(19) United States
(12) Patent Application Publication
(10) Pub. No.: US 2002/0184986 A1
(43) Pub. Date: Dec. 12, 2002

(54) Lower blade shaft for a roller cutting machine

(76) Inventors: Wilfried Oehmen, Grevenbroich (DE); Josef Pakula, Grevenbroich (DE)

Correspondence Address: FISH & NEAVE, 1251 AVENUE OF THE AMERICAS, 50TH FLOOR, NEW YORK, NY, 10020-1105, US

(21) Appl. No.: 10/090,335

(22) Filed: Mar. 4, 2002

(30) Foreign Application Priority Data
Mar. 8, 2001 (DE) 101 11 112.6-26

(51) Int. Cl. B26D 1/15

(52) U.S. Cl. 83/500; 83/508.3

(57) ABSTRACT

The invention relates to a lower blade shaft for a roller cutting machine for the lengthwise cutting of foils and strips into sectors with at least one lower blade (3). A flexible adjustment of such a lower blade shaft to various cutting widths according to the invention is ensured by having the lower blade shaft have a number of lower blades (3) exceeding the number of cuts, arranging the lower blades (3) in essentially regular intervals on the lower blade shaft, and selecting the distances between the lower blades (3) to permit a flexible choice of sector width.

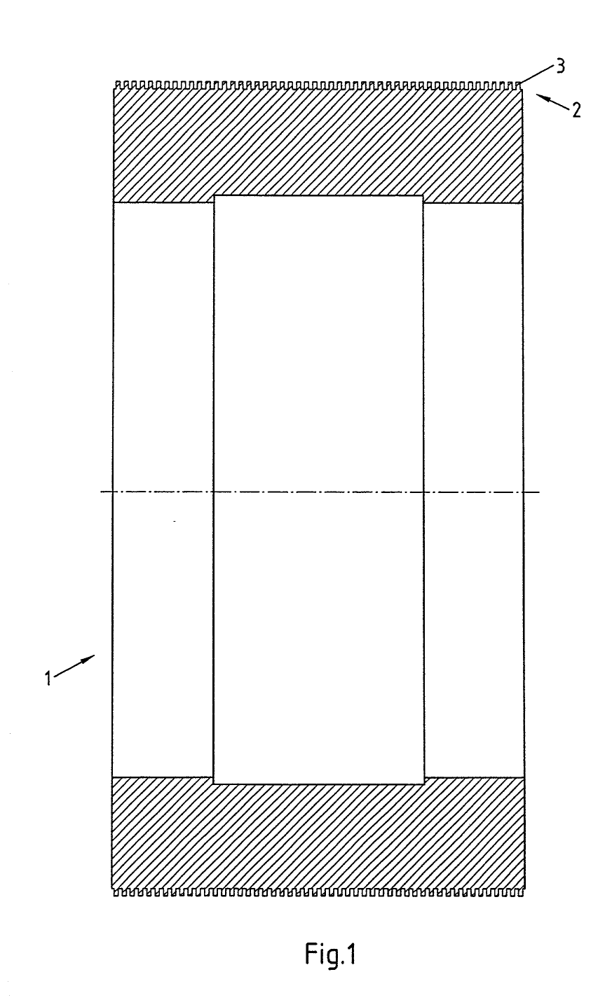

FIG. 1 is provided for the publication with abstract.

The invention relates to a lower blade shaft for a roller cutting machine for the lengthwise cutting of foils and strips into sectors with at least one lower blade, and a roller cutting machine for the lengthwise cutting of foils and strips into sectors.

Roller cutting machines are used in particular to cut aluminum foils and strips, but also to cut compounding materials made of aluminum and paper, as well as of aluminum and plastic, and to cut other foils, strips and composite materials in a thickness range of several μm to about one mm. The foils or strips to be cut can be either bare or lacquered. The compounding materials to be cut are fabricated via lamination or extrusion, for example.

The lower blade shaft according to the invention or roller cutting machine according to the invention shall be explained in the following based on the example of cutting aluminum foils or strips. Aluminum or aluminum materials are here understood as alloys containing at least 90% aluminum.

In order to fabricate aluminum foils and strips, ingots are cast in a first stage in widths of between 900 and 2200 mm, hot-rolled and then cold-rolled to the final thickness. Depending on the intended use in the subsequently processing, the aluminum foils and strips are fabricated to varying end thicknesses and widths. In this case, the end thickness is determined via pass reduction in the rolling process. The end width is fabricated via longitudinal pitching of the strips or foils on so-called roller cutting machines in single or multiple layers.

A roller cutting machine essentially consists of three structural units,

1. an unwind unit on which the so-called parent strip is unwound,

2. a cutting part, in which the strip is cut along its length into narrow sectors by blades, and

3. a wind unit, in which the previously cut sectors are wound into rolls.

This invention also relates in particular to the so-called shear cutting procedure. In this case, the strip or foil is guided over a lower blade shaft with a specific entanglement. An upper blade dipping into the lower blade shaft, e.g., designed either as a razor blade or circular knife, cuts the aluminum in a point with a shear or blade cut. The upper blade is pressed against the lower blade in a conventional manner by a spring. More recent procedures make use of pneumatic cylinders or diaphragm cylinders instead of a spring.

During the lengthwise cutting of foils or strips, the cutting widths for the strips to be cut must routinely be adjusted. To this end, the upper blades first have to be adjusted to the new cutting widths, which can be done comparatively easily and quickly. In addition to adjusting the upper blade to the cutting widths, the lower blade must also be adjusted to the new cutting widths. For this purpose, the entire lower blade shaft must be replaced in the known roller cutting machines, in order to incorporate a lower blade shaft with lower blades arranged on the position on the lower blade shaft that corresponds to the new cutting width. To this end, adapters are arranged on the lower blade shaft between the lower blades to establish the necessary distances. This gives rise to a considerable setup period, and hence high costs.

Proceeding from the prior art described above and the problems associated herewith, the object of this invention is to provide a lower blade shaft or roller cutting machine with which the set-up time for manufacturing altered cutting widths can be significantly reduced.

The object derived and described above is achieved for a lower blade shaft for a roller cutting machine for the lengthwise cutting of foils and strips into sectors with at least with at least one lower blade by virtue of the fact that the lower blade shaft has a number of lower blades exceeding the number of cuts, the lower blades are arranged in essentially regular intervals on the lower blade shaft, and the distances between the lower blades are selected to permit a flexible choice of strip width. The fact that lower blades are arranged on the lower blade shaft in such a way as to be able to flexibly select the width of the sectors to be cut ensures that the roller cutting machine can be adjusted to altered cutting widths without downtimes for conversion work on the lower blade shaft. Only the significantly easier to handle upper blades need to be positioned suitably relative to the lower blades to be allocated to the altered cutting width, so that the next cutting batch can be fabricated with the desired altered cutting widths. The considerably reduced setup times result in a significantly higher utilization of the machine run time, which in turn leads to clearly reduced costs for the cutting process.

The distance between the lower blades arranged on a lower blade shaft according to the invention can be reduced by designing the lower blades to alternate between lower blades for making left and right cuts. A reduced distance between the lower blades ensures a more flexible adaptation to the desired cutting widths.

The lower blades can be arranged to alternate between left and right cuts in a particularly suitable manner by designing the lower blades to have dual cutting edges on the tongue of a keyway-tongue division of the lower blade shaft.

Because the lower blade shaft has numerous cutting bushings in another embodiment of the lower blade shaft according to the invention, and the cutting bushings each have numerous lower blades, the entire lower blade shaft need not be changed out if the lower blades become worn in specific areas of the lower blade shaft. In a lower blade shaft designed in this way, the cutting bushings that show a particularly high level of wear can be exchanged, while those cutting bushings that show less or no wear can continue to be used.

In order to ensure as flexible a setting of the cutting widths as possible, it makes sense for the lower blades to be arranged at a distance of about 0.5 to 10 mm from each other. It is particularly advantageous to arrange (divide) the cutting edges at a distance of about 0.8 to 2 mm relative to each other.

In particular when cutting aluminum foils, it makes sense relative to the possible pressing of the lower blade shaft profile onto the aluminum foil to be cut to hold the keyway widths as small as possible. A keyway width of 0.8 to 2 mm has proven to be particularly suitable with respect to a slight pressing, and the provision of sufficient space for immersing an upper blade.

Finally, the object derived and described above is achieved by a roller cutting machine for the lengthwise slitting of foils and strips into sectors with a lower blade shaft according to the invention and at least two upper blades that immerse into the lower blade shaft.

There are numerous ways to advantageously configure and further develop the lower blade shaft and the roller cutting machine according to the invention. To this end, for example, reference is made on the one hand to the claims subsequent to claim 1, and on the other hand to the description of a preferred embodiment in conjunction with the drawing. The drawing shows

FIG. 1 a sectional view of a cutting bush for an embodiment of a lower blade shaft according to the invention,

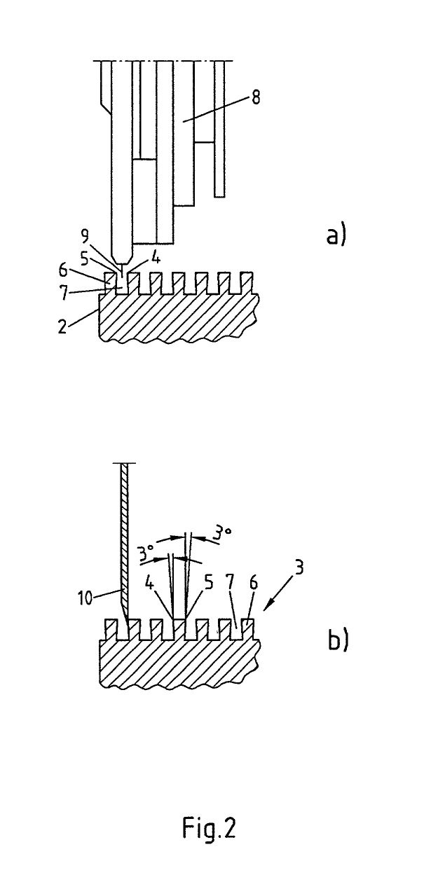

FIGS. 2a), b) the interaction of an embodiment of a lower blade shaft according to the invention with an upper blade designed as a razor blade or circular knife, and

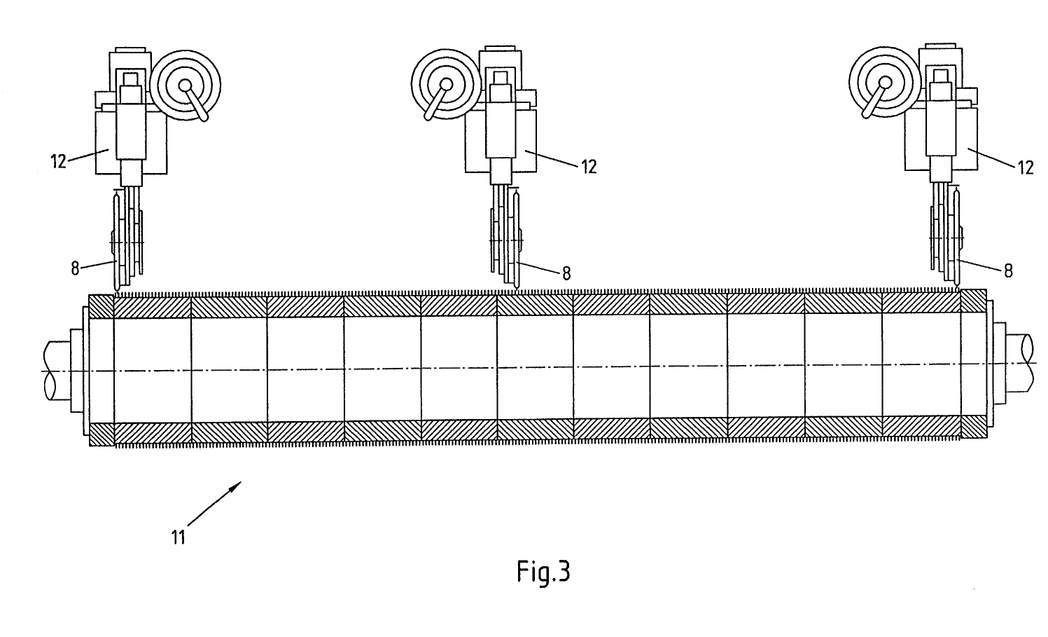

FIG. 3 an embodiment of a lower blade shaft with set upper blades.

The cutting bushing 1 of a lower blade shaft shown on FIG. 1 consists in the embodiment of a hollow cylinder roughly 10 cm long, on which numerous lower blades 3 are arranged on the outer cylinder surface in a keyway-tongue division 2. As clearly evident from FIGS. 2a) and b), the lower blades 3 are here designed as dual cutting edges 4, 5 on the tongue 6 of the keyway-tongue division 2.

The distance between the cutting edges 4, 5 measures about 0.8 mm via the keyways 7, and about 1.2 mm via the tongues 6 in the embodiment shown.

In the embodiment shown on FIG. 2a), an upper blade 8 is designed as the upper blade of a razor blade cutting system. Accordingly, a razor blade 9 immerses into the lower blade 3 within a keyway 7.

FIG. 2b) shows the immersion of a circular knife 10 as an upper blade into the lower blades 3 in a shearcutting system. FIG. 2b) also shows that the cutting edges 4, 5 have a cutting angle of about 3°.

In the embodiment of a lower blade shaft according to the invention shown on FIG. 2, the tongues 6 have a height of about 2 mm.

FIG. 3 of the drawing shows an embodiment of a lower blade shaft 11 built into a roller cutting machine not shown in detail. 3 upper blades 8 become immersed in the razor blade cutting system 1 in three of the roughly one thousand five hundred lower blades arranged on the lower blade shaft 11. The lower blades 8 are here guided by means of upper blade adjusting equipment 12.

As particularly evident from FIG. 3, any cutting width can be set in the modular dimension set via the distance between the cutting edges by simply shifting the upper blade adjusting equipment 12 relative to a lower blade 11 according to the invention.

1. A lower blade shaft for a roller cutting machine for the lengthwise cutting of foils and strips into sectors with at least one lower blade (3),
characterized in that the lower blade shaft has a number of lower blades (3) exceeding the number of cuts, the lower blades (3) are arranged in essentially regular intervals on the lower blade shaft, and the distances between the lower blades (3) are selected to permit a flexible choice of sector width.

2. The lower blade shaft according to claim 1,
characterized in that the lower blades (3) are designed to alternate between lower blades for making left and right cuts.

3. The lower blade shaft according to claim 2,
characterized in that the lower blades (3) are designed to have dual cutting edges (4, 5) on the tongue (6) of a keyway-tongue division of (2) the lower blade shaft.

4. The lower blade shaft according to one of claims 1 to 3, characterized in that the lower blade shaft has numerous cutting bushings (1), and the cutting bushings (1) each have numerous lower blades (3).

5. The lower blade shaft according to one of claims 1 to 4, characterized in that the lower blades (3) are arranged a distance of about 0.5 to 10 mm from each other.

6. The lower blade shaft according to claim 5,
characterized in that the lower blades (3) are arranged a distance of about 1 to 2 mm from each other.

7. The lower blade shaft according to one of claims 3 to 6, characterized in that the keyways (7) have a width of 0.8 to 2 mm.

8. A roller cutting machine for the lengthwise cutting of foils and strips into sectors with a lower blade shaft (11) according to one of claims 1 to 7 and at least two upper blades (8) that immerse into the lower blade shaft (11).
